(19) United States
(12) Patent Application Publication
(10) Pub. No.: US 2023/0025683 A1
(43) Pub. Date: Jan. 26, 2023

(54) OPTIMIZED COOKING METHOD SELECTION

(71) Applicant: Haier US Appliance Solutions, Inc., Wilmington, DE (US)

(72) Inventors: Milamaria Spurlock Songer, Louisville, KY (US); John Gilman Chapman, JR., Louisville, KY (US)

(21) Appl. No.: 17/382,954

(22) Filed: Jul. 22, 2021

(51) Int. Cl. A47J 36/32; A23L 5/10; G06F 9/451

(52) U.S. Cl. CPC A47J 36/321; A23L 5/15; G06F 9/451; A23V 2002/00; A47J 37/0629

(57) ABSTRACT

A guided cooking method uses a plurality of cooking appliances and a remote user interface device. The remote user interface device receives an input indicating a food item and generates a list of recommendations, including at least one recommended cooking appliance and at least one recommended cycle, for preparing the indicated food item. The method also includes receiving a selection response corresponding to one entry from the list of recommendations via the remote user interface device. The method may then include transmitting a signal from the remote user interface device to the cooking appliance indicated by the selection response to activate the cooking appliance to perform the cycle indicated by the selection response, or providing step-by-step instructions, from the remote user interface device, for operating the cooking appliance indicated by the selection response to perform the cycle indicated by the selection response.

### FIELD OF THE INVENTION

The subject matter of the present disclosure relates generally to cooking appliances, and more particularly to methods of selecting an optimal cooking appliance from a plurality of cooking appliances to cook a particular food item.

### BACKGROUND OF THE INVENTION

Consumers typically have multiple cooking appliances in their kitchen, and such appliances collectively provide hundreds of cooking cycle options and parameters across multiple different operator panels and menu systems. However, usage data has shown that simple cycles are the most commonly and frequently used, even when superior, precision engineered cycles are available for the desired end result. In many cases, users are unfamiliar or uncomfortable with the more complex and specialized cycles that are available, leading to underutilization of such cycles and overreliance on common cycles which may be less adapted for a particular food item.

Accordingly, simplified user interfaces and methods that provides access to multiple appliances and multiple cycle options or parameters for each appliance in a single interface would be desirable.

### BRIEF DESCRIPTION OF THE INVENTION

Aspects and advantages of the invention will be set forth in part in the following description, or may be apparent from the description, or may be learned through practice of the invention.

In one exemplary embodiment, a guided cooking method is provided. The guided cooking method uses a plurality of cooking appliances and a remote user interface device. The method includes receiving, by the remote user interface device, an input indicating a food item and generating, by the remote user interface device, a list of recommendations for preparing the indicated food item. The list of recommendations includes at least one recommended cooking appliance of the plurality of cooking appliances and at least one recommended cycle for each recommended cooking appliance. The method also includes receiving a selection response corresponding to one entry from the list of recommendations via the remote user interface device. The method then includes transmitting a signal from the remote user interface device to the cooking appliance indicated by the selection response to activate the cooking appliance indicated by the selection response to perform the cycle indicated by the selection response.

In another exemplary embodiment, a guided cooking method is provided. The method uses a plurality of cooking appliances and a remote user interface device. The method includes receiving, by the remote user interface device, an input indicating a food item and generating, by the remote user interface device, a list of recommendations for preparing the indicated food item. The list of recommendations includes at least one recommended cooking appliance of the plurality of cooking appliances and at least one recommended cycle for each recommended cooking appliance. The method also includes receiving a selection response corresponding to one entry from the list of recommendations via the remote user interface device. The method then includes providing step-by-step instructions, from the remote user interface device, for operating the cooking appliance indicated by the selection response to perform the cycle indicated by the selection response.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary system including an exemplary interface assembly and an exemplary cooking appliance according to one or more example embodiments of the present subject matter.

FIG. 2 provides a schematic side view of the system of FIG. 1.

FIG. 3 provides a front view of another exemplary cooking appliance according to one or more example embodiments of the present subject matter.

FIG. 4 provides a schematic perspective view of the cooking appliance of FIG. 3.

FIG. 5 provides a schematic perspective view of another embodiment of the cooking appliance of FIG. 3.

FIG. 6 provides a front view of yet another exemplary cooking appliance according to one or more example embodiments of the present subject matter.

FIG. 7 provides a section view of the cooking appliance of FIG. 6.

FIG. 8 provides a schematic view of a remote user interface device and a plurality of cooking appliances according to one or more example embodiments of the present disclosure.

FIG. 9 provides a flow chart diagram illustrating a guided cooking method according to one or more example embodiments of the present subject matter.

FIG. 10 provides a flow chart diagram illustrating another guided cooking method according to one or more additional example embodiments of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents. As used herein, terms of approximation, such as “approximately,” “substantially,” or “about,” refer to being within a ten percent (10%) margin of error of the stated value. Moreover, as used herein, the terms “first,” “second,” and “third” may be used interchangeably to distinguish one component from another and are not intended to signify location or importance of the individual components.

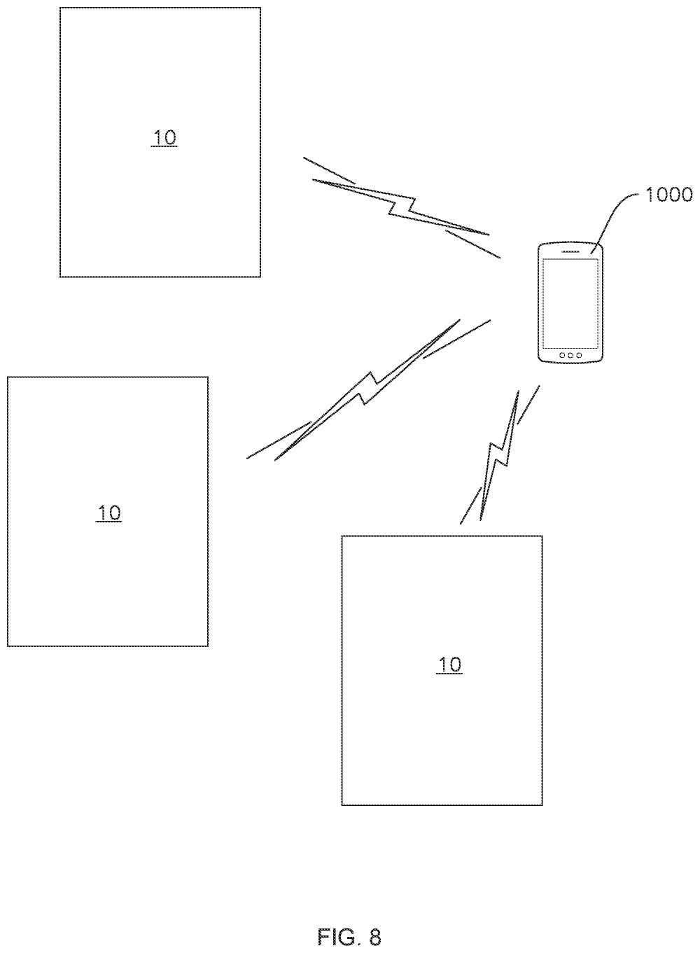

The present disclosure generally pertains to a single, common and simplified, user interface for multiple cooking appliances, where the user interface is provided on a remote user interface device, e.g., a device separate and apart from the cooking appliances. Thus, user interfaces and related devices and methods disclosed herein are usable with a plurality of cooking appliances. The plurality of cooking appliances, e.g., cooking appliances 10 as illustrated in FIG. 8 and described below, may include any two or more of the following example appliances, as well as other cooking appliances as will be recognized and understood by those of ordinary skill in the art.

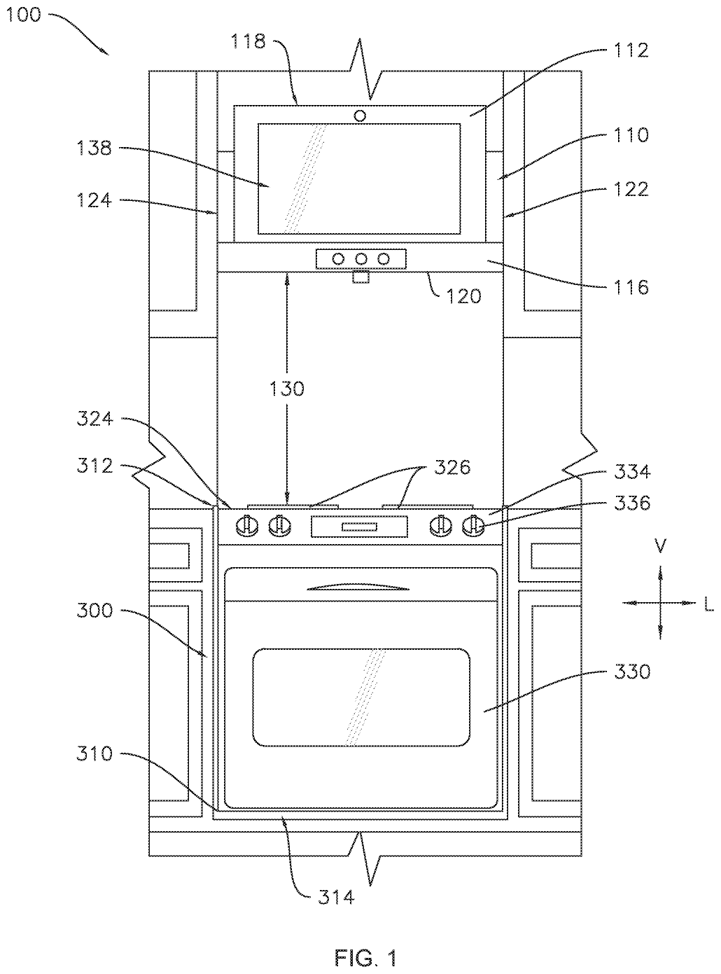

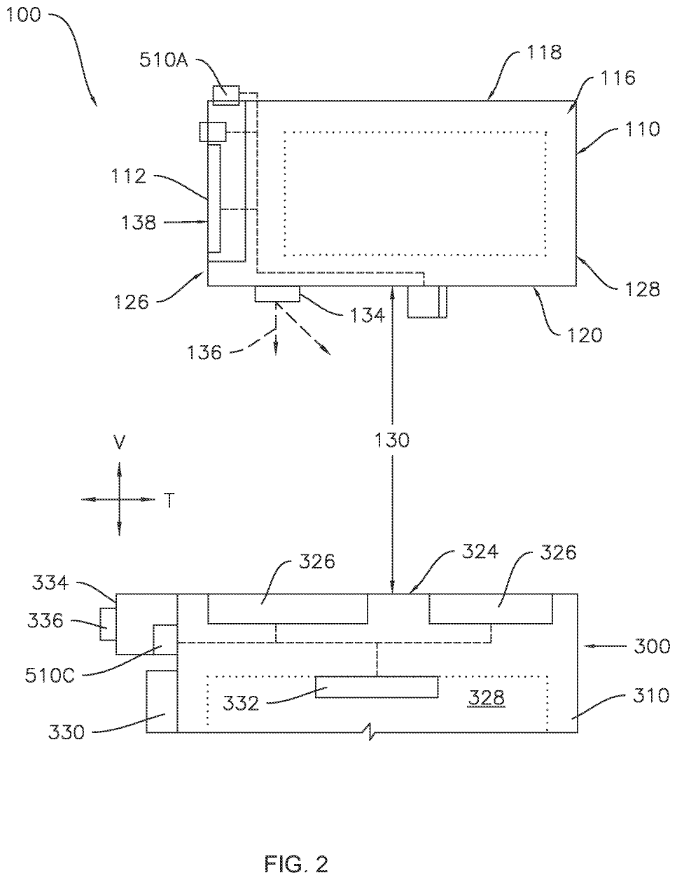

Turning to the figures, FIGS. 1 and 2 provide various views of a system 100 according to exemplary embodiments of the present disclosure. System 100 generally includes an interactive assembly 110 having a controller 510A in operable communication with an image monitor 112 that is generally positioned above a cooktop appliance 300.

As shown, cooktop appliance 300 defines a vertical direction V, a lateral direction L, and a transverse direction T, for example, at a cabinet 310. The vertical, lateral, and transverse directions V, L, and T are mutually perpendicular and form an orthogonal direction system. As shown, cooktop appliance 300 extends along the vertical direction V between a top portion 312 and a bottom portion 314, along the lateral direction L between a left side portion and a right side portion; and along the traverse direction T between a front portion and a rear portion.

Cooktop appliance 300 can include a chassis or cabinet 310 and a cooktop surface 324 having one or more heating elements 326 for use in, for example, heating or cooking operations. In one example embodiment, cooktop surface 324 is constructed with ceramic glass. In other embodiments, however, cooktop surface 324 may include any another suitable material, such as a metallic material (e.g., steel) or another suitable non-metallic material. Heating elements 326 may be various sizes and may employ any suitable method for heating or cooking an object, such as a cooking utensil (not shown), and its contents. In one embodiment, for example, heating element 326 uses a heat transfer method, such as electric coils or gas burners, to heat the cooking utensil. In another embodiment, however, heating element 326 uses an induction heating method to heat the cooking utensil directly. In turn, heating element 326 may include a gas burner element, resistive heat element, radiant heat element, induction element, or another suitable heating element.

In some embodiments, the cabinet 310 may be insulated and may define a cooking chamber 328 selectively enclosed by a door 330. One or more heating elements 332 (e.g., top broiling elements or bottom baking elements) may be positioned within cabinet 310 to heat cooking chamber 328. Heating elements 332 within cooking chamber 328 may be provided as any suitable element for cooking the contents of cooking chamber 328, such as an electric resistive heating element, a gas burner, a microwave element, a halogen element, etc. Thus, cooktop appliance 300 may be referred to as an oven range appliance. As will be understood by those skilled in the art, cooktop appliance 300 is provided by way of example only, and the present subject matter may be used in the context of any suitable cooking appliance, such as a double oven range appliance or a standalone cooktop (e.g., fitted into a surface of a kitchen counter). Thus, the example embodiments illustrated and described are not intended to limit the present subject matter to any particular cooking chamber or heating element configuration, except as otherwise indicated.

As illustrated, a user interface panel 334 may be provided on cooktop appliance 300. Although shown at front portion of cooktop appliance 300, another suitable location or structure (e.g., a backsplash) for supporting user interface panel 334 may be provided in alternative embodiments. In some embodiments, user interface panel 334 includes input components or controls 336, such as one or more of a variety of electrical, mechanical, or electro-mechanical input devices. Controls 336 may include, for example, rotary dials, knobs, push buttons, and touch pads. A controller 510C is in communication with user interface panel 334 and controls 336 through which a user may select various operational features and modes and monitor progress of cooktop appliance 300. In additional or alternative embodiments, user interface panel 334 includes a display component, such as a digital or analog display in communication with a controller 510C and configured to provide operational feedback to a user. In certain embodiments, user interface panel 334 represents a general purpose I/O (“GPIO”) device or functional block.

As shown, controller 510C is communicatively coupled (i.e., in operative communication) with user interface panel 334 and its controls 336. Controller 510C may also be communicatively coupled with various operational components of cooktop appliance 300 as well, such as heating elements (e.g., 326, 332), sensors, and the like. Input/output (“I/O”) signals may be routed between controller 510C and the various operational components of cooktop appliance 300. Thus, controller 510C can selectively activate and operate these various components. Various components of cooktop appliance 300 are communicatively coupled with controller 510C via one or more communication lines such as, for example, conductive signal lines, shared communication busses, or wireless communications bands.

In some embodiments, controller 510C includes one or more memory devices and one or more processors. The processors can be any combination of general or special purpose processors, CPUs, or the like that can execute programming instructions or control code associated with operation of cooktop appliance 300. The memory devices (i.e., memory) may represent random access memory such as DRAM or read only memory such as ROM or FLASH. In one embodiment, the processor executes programming instructions stored in memory. The memory may be a separate component from the processor or may be included onboard within the processor. Alternatively, controller 510C may be constructed without using a processor, for example, using a combination of discrete analog or digital logic circuitry (such as switches, amplifiers, integrators, comparators, flip-flops, AND gates, and the like) to perform control functionality instead of relying upon software.

In certain embodiments, controller 510C includes a network interface such that controller 510C can connect to and communicate over one or more networks with one or more network nodes. Controller 510C can also include one or more transmitting, receiving, or transceiving components for transmitting/receiving communications with other devices communicatively coupled with cooktop appliance 300. Additionally or alternatively, one or more transmitting, receiving, or transceiving components can be located off-board of controller 510C. Generally, controller 510C can be positioned in any suitable location throughout cooktop appliance 300. For example, controller 510C may be located proximate user interface panel 334 toward front portion of cooktop appliance 300.

As shown, one or more casings (e.g., hood casing 116) may be provided above cooktop appliance 300 along the vertical direction V. For example, a hood casing 116 may be positioned above cooktop appliance 300. Hood casing 116 includes a plurality of outer walls and generally extends along the vertical direction V between a top end 118 and a bottom end 120, along the lateral direction L between a right side end 122 and a left side end 124, e.g., “right” and “left” as used herein refer to from a perspective of a user standing in front of system 100. The hood casing 116 may also extend along the transverse direction T between a front end 126 and a back end 128. In some embodiments, hood casing 116 is spaced apart from cooktop surface 324 along the vertical direction V. An open region 130 may thus be defined along the vertical direction V between cooktop surface 324 and bottom end 120.

In optional embodiments, hood casing 116 is formed as a range hood. For example, a ventilation assembly may be provided within hood casing 116 which may direct an airflow from the open region 130 and through hood casing 116. However, a range hood is provided by way of example only. Other configurations may be used within the spirit and scope of the present disclosure. For example, although a generally rectangular shape is illustrated, any suitable shape or style may be adapted to form the structure of hood casing 116.

In some embodiments, a lighting assembly 134 is provided above cooktop surface 324 (e.g., along the vertical direction V). For instance, lighting assembly 134 may be mounted to hood casing 116 (e.g., directly above cooktop surface 324). Generally, lighting assembly 134 includes one or more selectable light sources directed toward cooktop surface 324. In other words, lighting assembly 134 is oriented to project a light (as indicated at arrows 136) to cooktop appliance 300 through open region 130 and illuminate at least a portion of cooktop surface 324. The light sources may include any suitable light-emitting elements, such as one or more light emitting diode (LED), incandescent bulb, fluorescent bulb, halogen bulb, etc.

During use, lighting assembly 134 may be selectively activated to illuminate a portion of cooktop appliance 300 (e.g., cooktop surface 324) based on a received light visibility signal. For instance, lighting assembly 134 may be activated by controller 510A based on direct user input (e.g., depressing a dedicated switch, a gesture control signal, voice control signal, etc.). In other words, the light visibility signal may be an isolated user input signal. Alternatively, the light visibility signal may be an automatically-generated signal that does not require direct user input. The light visibility signal may indicate additional light is needed above cooktop appliance 300. In turn, controller 510A may automatically activate lighting assembly 134 based on a determined condition. Optionally, one or more camera assemblies may be mounted to hood casing 116 and directed toward cooktop appliance 300 or an area in front of cooktop appliance 300 (e.g., to operate with or independently of lighting assembly 134).

In some embodiments, image monitor 112 is provided above cooktop surface 324 (e.g., along the vertical direction V). For instance, image monitor 112 may be mounted to or supported on hood casing 116 (e.g., directly above cooktop surface 324) proximal to the front end 126. Generally, image monitor 112 may be any suitable type of mechanism for visually presenting a digital (e.g., interactive) image. For example, image monitor 112 may be a liquid crystal display (LCD), a plasma display panel (PDP), a cathode ray tube (CRT) display, etc. Thus, image monitor 112 includes an imaging surface 138 (e.g., screen or display panel) at which the digital image is presented or displayed as an optically-viewable picture (e.g., static image or dynamic video) to a user. Optionally, a protective transparent panel (e.g., formed from a transparent glass, plastic, etc.) may be positioned across or over imaging surface 138. In some such embodiments, the protective transparent panel is mounted within or supported on hood casing 116 forward from imaging surface 138 along the transverse direction T.

The optically-viewable picture at the imaging surface 138 may correspond to any suitable signal or data received or stored by interactive assembly 110 (e.g., at controller 510A). As an example, image monitor 112 may present recipe information in the form of viewable text or images. As another example, image monitor 112 may present a remotely captured image, such as a live (e.g., real-time) dynamic video stream received from a separate user or device. As yet another example, image monitor 112 may present a graphical user interface (GUI) that allows a user to select or manipulate various operational features of interactive assembly 110 or cooktop appliance 300. During use of such GUI embodiments, a user may engage, select, or adjust the image presented at image monitor 112 through any suitable input, such as gesture controls detected through a camera assembly, voice controls detected through one or more microphones, associated touch panels (e.g., capacitance or resistance touch panel) sensors overlaid across imaging surface 138, or any other suitable input.

As illustrated, the imaging surface 138 is directed toward the area forward from the cooktop appliance 300. During use, a user standing in front of cooktop appliance 300 may thus see the optically-viewable picture (e.g., recipe, dynamic video stream, graphical user interface, etc.) displayed at the imaging surface 138. Optionally, the imaging surface 138 may be positioned at a rearward non-orthogonal angle relative to the vertical direction V. In other words, the imaging surface 138 may be inclined such that an upper edge of the imaging surface 138 is closer to the rear end 128 of hood casing 116 than a lower edge of the imaging surface 138 is. In some such embodiments, the non-orthogonal angle is between 1° and 15° relative to the vertical direction V. In certain embodiments, the non-orthogonal angle is between 2° and 7° relative to the vertical direction V.

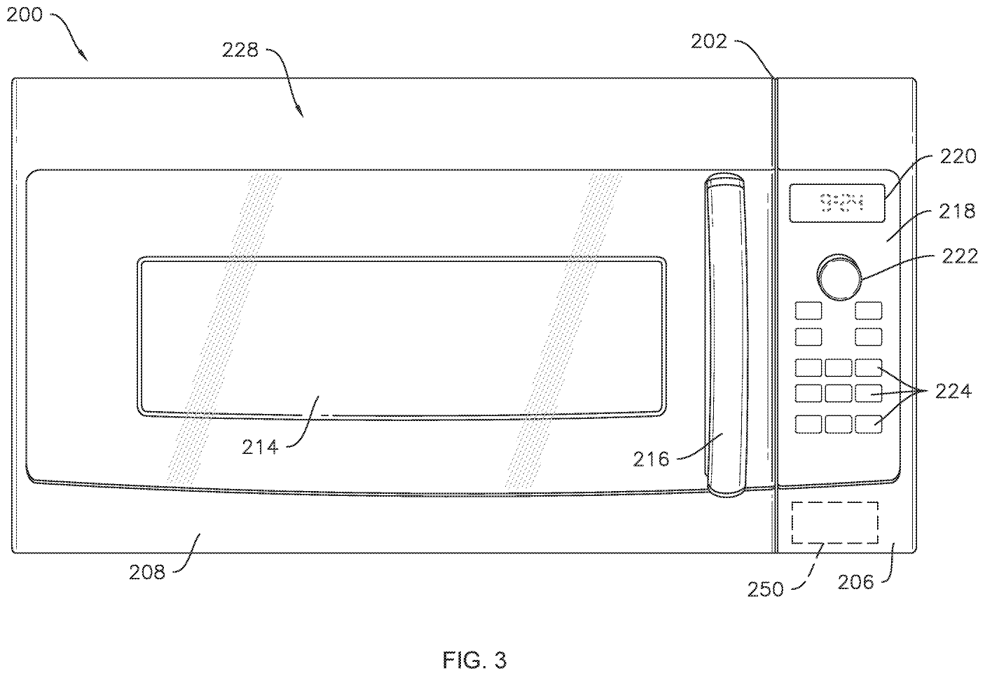

FIG. 3 provides a front view of a cooking appliance 200 according to an example embodiment of the present subject matter. Cooking appliance 200 may, in some example embodiments, be an “over-the-range” oven. In other example embodiments, the cooking appliance 200 may be a countertop oven, a wall oven, or may be provided in various other oven configurations as will be recognized by those of skill in the art.

Cooking appliance 200 includes a housing or casing 202 that defines a cooking cavity 228. Food items can be received within cooking cavity 228. A door 208 is rotatably mounted to casing 202 and is movable between an open position and a closed position (shown in FIG. 3) to provide selective access to cooking cavity 228. A window 214 in door 208 is provided for viewing food items in the cooking cavity 228, and a handle 216 is secured to door 208. Handle 216 can be formed of plastic, for example, and can be injection molded.

As may be seen, e.g., in FIGS. 3 through 5, the cooking appliance 200 may define a vertical direction V, a lateral direction L, and a transverse direction T. The vertical direction V, the lateral direction L, and the transverse direction T may be mutually perpendicular. In particular, the cooking appliance 200 may extend between a top and a bottom along the vertical direction, between a left side and a right side along the lateral direction L, and between a front and a back along the transverse direction T. For example, “front,” “back,” “left,” and “right” may be defined from the perspective of a user standing in front of the cooking appliance 200 to access the cooking cavity 228 therein, e.g., via the door 208.

Cooking appliance 200 also includes a control panel frame 206. A control panel 218 is mounted within control panel frame 206. Control panel 218 includes a display device 220 for presenting various information to a user. Control panel 218 also includes one or more input devices. For this embodiment, the input devices of control panel 218 include a knob or dial 222 and tactile control buttons 224. Selections are made by rotating dial 222 clockwise or counter-clockwise, and when the desired selection is displayed, pressing dial 222. For example, many cooking cycles and other cooking algorithms can be preprogrammed in or loaded onto a memory device of a controller 250 of cooking appliance 200. Additionally, new or updated cooking cycles may be downloaded to the memory device of the controller 250, such as from a remote database, e.g., a cloud server, via a network communications module of the controller 250 and stored in the memory device. One or more cooking parameters can be selected by rotating dial 222 until the desired value for the parameter is displayed and then pressing dial 222, and the process may be repeated for each parameter when more than one parameter is being selected or adjusted. Instructions and selections are displayed on display device 220. Furthermore, in some embodiments, display device 220 can also be used as an input device. For instance, in such embodiments, display device 220 can be a touchscreen device. In some embodiments, display device 220 is the only input device of control panel 218.

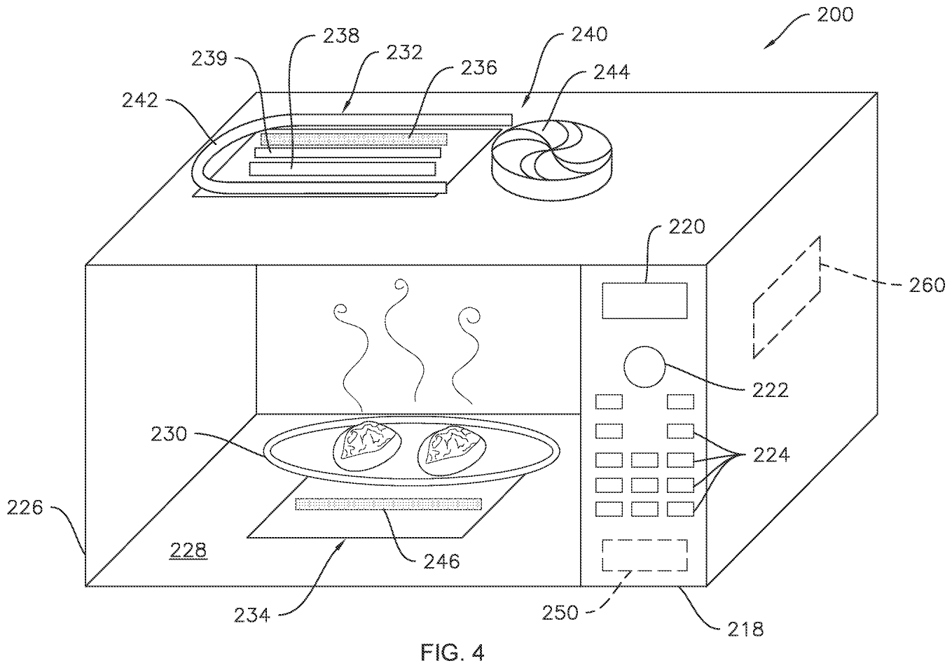

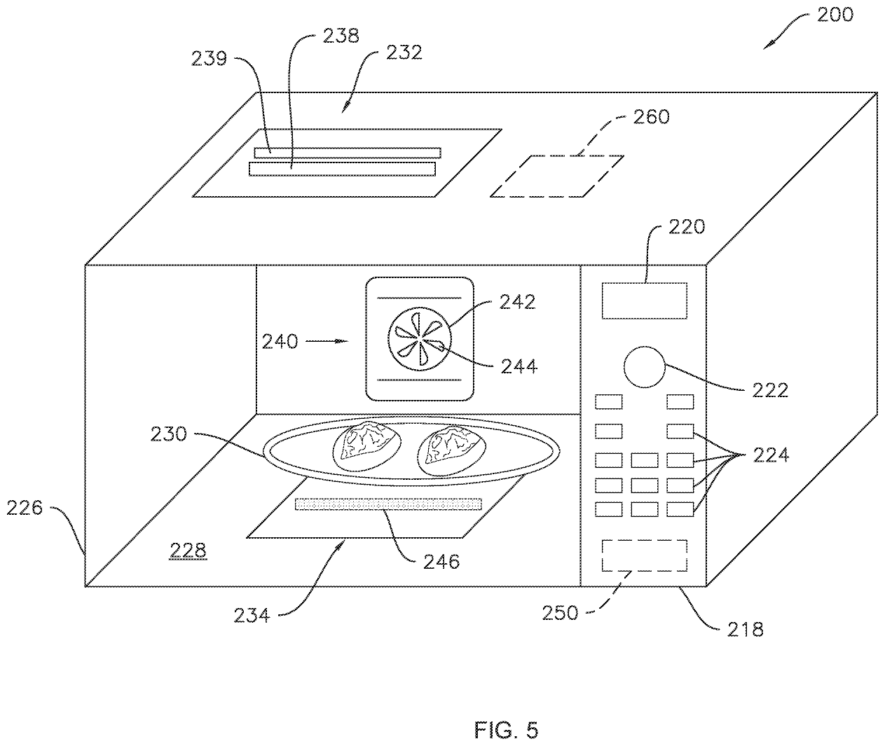

FIG. 4 provides a schematic view of cooking appliance 200 in one or more example embodiments and FIG. 5 provides a schematic view of cooking appliance 200 in one or more additional example embodiments. As shown in FIGS. 4 and 5, in some example embodiments, casing 202 (FIG. 3) of cooking appliance 200 includes a shell 226. Shell 226 of casing 202 delineates the interior volume of cooking cavity 228. The walls of shell 226 may be constructed using high reflectivity (e.g., 72% reflectivity) stainless steel. A turntable 230 is located in cooking cavity 228 and is rotatable about an axis of rotation, e.g., for rotating food items during a cooking operation.

Further, cooking appliance 200 includes a microwave module 260, an upper heater module 232, a lower heater module 234, and a convection module 240. In the example embodiment of FIG. 4, the convection module 240 is positioned above the cooking cavity 228. FIG. 5 schematically illustrates an additional example embodiment of the cooking appliance 200, where the convection module 240 (including sheath heater 242 and convection fan 244) is provided at a back of the cooking cavity 228. In some embodiments, microwave module 260 is located on a side of cooking cavity 228 (e.g., as illustrated in FIG. 4), while in other example embodiments, the microwave module 260 may be located above the cooking cavity 228 (e.g., as illustrated in FIG. 5). The microwave module 260 delivers microwave energy into cooking cavity 228. In some embodiments, the microwave module 260 includes a magnetron to provide the microwave energy. In other embodiments, the microwave module 260 may also or instead include a solid-state radio frequency device, e.g., a low-voltage printed circuit board with semiconductors embedded therein which output microwave energy at various frequencies and power output levels. Upper heater module 232 can include one or more heating elements. For instance, upper heating module 232 can include one or more halogen cooking lamps and/or one or more ceramic heaters. For the depicted embodiment of FIG. 4, upper heating module 232 includes a ceramic heater 236 and a halogen cooking lamp 238. In some example embodiments, upper heater module 232 has at least two halogen lamps 238, 239 configured to deliver radiant and thermal energy into the cooking cavity 228, such as in the example embodiment depicted in FIG. 5.

Convection module 240 includes a sheath heater 242 and a convection fan 244. Convection fan 244 is provided for blowing or otherwise moving air over sheath heater 242 of convection module 240 and into cooking cavity 228, e.g., for convection cooking. Lower heater module 234 includes at least one heating element. The heating element of lower heater module 234 can be a ceramic heater or a halogen lamp, for example. For the example embodiments illustrated in FIGS. 4 and 5, the heating element of lower heater module 234 is illustrated as a ceramic heater 246. In various embodiments, cooking appliance 200 may be a 240V cooking appliance or a 120V cooking appliance, for example.

The specific heating elements of upper and lower heater modules 232, 234, convection module 240, and radio frequency (RF) generation system of microwave module 260 (e.g., a magnetron or solid state RF generation system) can vary from embodiment to embodiment, and the elements and systems described above are exemplary only. For example, the upper heater module 232 can include any combination of heaters including combinations of halogen lamps, ceramic lamps, and/or sheath heaters. Similarly, lower heater module 234 can include any combination of heaters including combinations of halogen lamps, ceramic lamps, and/or sheath heaters. In addition, the heaters can all be one type of heater. The specific ratings and number of lamps and/or heaters utilized in the upper and lower modules 232, 234 and convection module 240 can vary from embodiment to embodiment. Generally, the combinations of lamps, heaters, and RF generation system is selected to provide the desired cooking characteristics for precision cooking in various modes and/or operations.

As shown in FIGS. 3 through 5, cooking appliance 200 includes a controller 250. Controller 250 of cooking appliance 200 can include one or more processor(s) and one or more memory device(s). The processor(s) of controller 250 can be any suitable processing device, such as a microprocessor, microcontroller, integrated circuit, or other suitable processing device. The memory device(s) of controller 250 can include any suitable computing system or media, including, but not limited to, non-transitory computer-readable media, RAM, ROM, hard drives, flash drives, or other memory devices. The memory device(s) of controller 250 can store information accessible by the processor(s) of controller 250 including instructions that can be executed by the processor(s) of controller 250 in order to execute various cooking operations or cycles, e.g., a meal cook cycle. Controller 250 is communicatively coupled with various operational components of cooking appliance 200, such as components of microwave module 260, upper heater module 232, lower heater module 234, convection module 240, and control panel 218, including display device 220, dial 222, the various control buttons 224, etc. Input/output (“I/O”) signals may be routed between controller 250 and control panel 218 as well as other operational components of cooking appliance 200. Controller 250 can execute and control cooking appliance 200 in various cooking operations or cycles, such as precision cooking, which includes microwave and convection/bake modes.

Cooking appliance 200 can operate in various modes or cycles, and the descriptions set forth herein are exemplary only. In addition, operation and use of cooking appliance 200 is not limited to a specific order of steps. Various steps can be performed in orders different from the exemplary order described herein.

In some embodiments, the cooking appliance 200 may be operable in one or more convection/bake modes. In one example convection/bake mode, a user selects “Convection/Bake” from control panel 218, and then uses dial 222 to select a temperature and cook time. Lower ceramic heater 246 and sheath heater 242 are then energized to preheat the air in cooking cavity 228. The food is then placed in cooking cavity 228 and cooking begins. During the cooking cycle, convection fan 244 circulates air to assure even cooking. Controller 250 can activate convection fan 244 (e.g., via one or more command signals) such that convection fan 244 moves air over sheath heater 242, and in some embodiments heating elements of upper heater module 232. In this way, heated air is moved into cooking cavity 228, e.g., for convection cooking.

Cooking appliance 200 may also operate in one or more microwave modes, for example a microwave only mode, or the microwave module 260 may operate in conjunction with one or more various other heating modules in other modes. Generally, for the modes which utilize microwave module 260, the user places food in cooking cavity 228 on turntable 230. The user then selects “Microwave,” “Express,” or other applicable cooking mode (e.g., a cooking cycle which utilizes the microwave module in conjunction with other heating modules) from control panel 218. Dial 222, for example, can be utilized to select the cooking mode, e.g., rotating the dial 222 until the cooking mode is displayed or highlighted, and the user may then select “Start” from control panel 218. The microwave module 260 is then energized in accordance with the user selections. In some embodiments, the user can select the desired cook time and power level and then may select “START” to commence the microwave only cooking operation.

In some embodiments, such as when the cooking appliance 200 is operated according to a predetermined or predefined precision cooking cycle, as described in more detail below, the cooking appliance 200 may operate one or more of the convection module 240, the lower heating module 234, the upper heating module 232, and the microwave module 260 in various combinations during a single cycle. For example, some embodiments may include operating two or more of the modules at various times, sequentially and/or simultaneously, during a single cycle. Such cycles may also include varying the rotational speed and/or direction of the turntable 230 at various points in time during the cycle. In various embodiments, the rotation of the turntable 230 may be controlled by software, and may be controlled based on an operating mode of the cooking appliance 200, cooking cycle sequences, and/or user input. Also, when one or more heating modules of the cooking appliance 200 are adjusted according to the predefined precision cooking cycle, such adjustments may be synchronized with the rotation of the turntable 230.

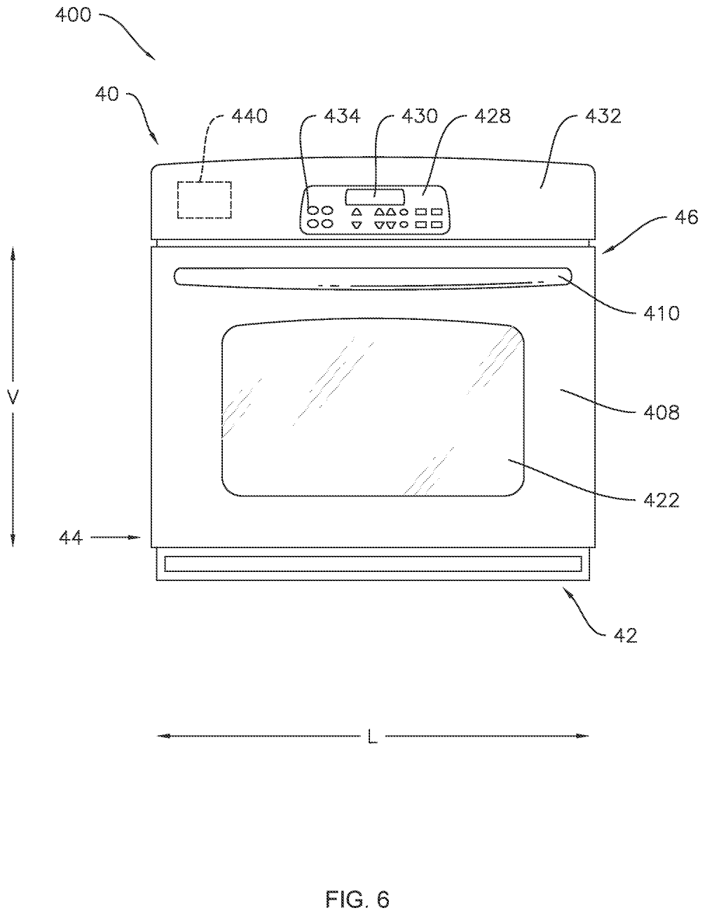

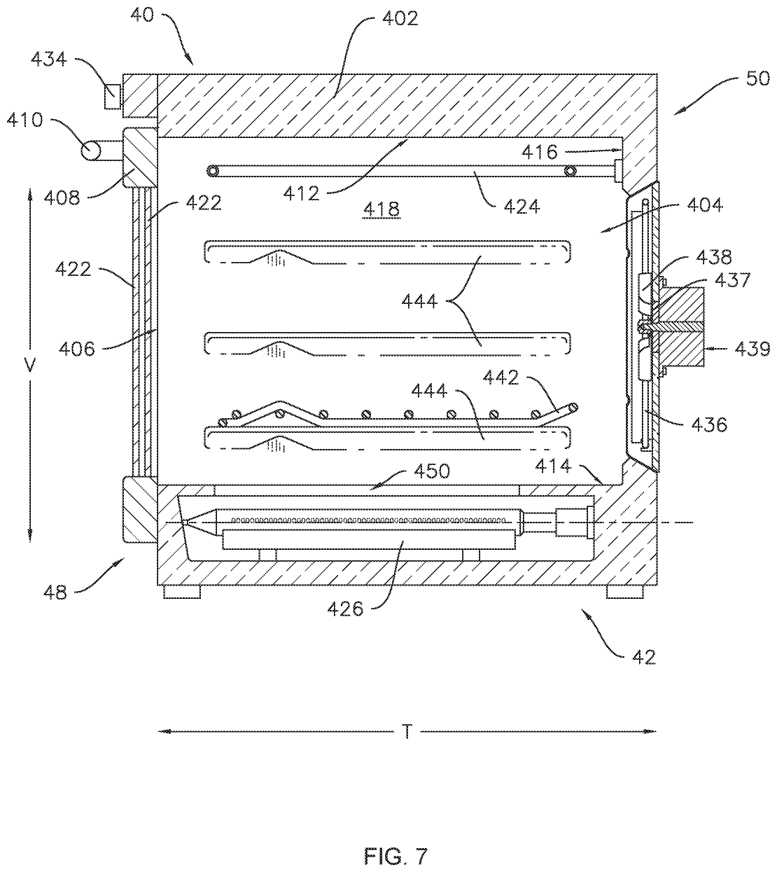

FIGS. 6 and 7 illustrate another exemplary cooking appliance, which in this example is an oven appliance 400 according to an exemplary embodiment of the present subject matter. Oven appliance 400 includes an insulated cabinet 402 which defines a vertical direction V, a lateral direction L, and a transverse direction T. The vertical, lateral, and transverse directions V, L, and T are mutually perpendicular and form an orthogonal direction system. Cabinet 402 extends between a top portion 40 and a bottom portion 42 along the vertical direction V. Cabinet 402 extends between a left side 44 and a right side 46 along the lateral direction L and between a front portion 48 and a back portion 50 along the transverse direction T.

Still referring to FIGS. 6 and 7, for this exemplary embodiment, oven appliance 400 includes an insulated cabinet 402 with an interior cooking chamber 404 defined by a top wall 412, a floor or bottom wall 414, a back wall 416, and a pair of opposing side walls 418. Cooking chamber 404 is configured for the receipt of one or more food items to be cooked. Oven appliance 400 includes a door 408 pivotally mounted to cabinet 402 at the opening 406 of cabinet 402 to permit selective access to cooking chamber 404 through opening 406. A handle 410 is mounted to door 408 and assists a user with opening and closing door 408. For example, a user can pull on handle 410 to open or close door 408 and access cooking chamber 404.

Oven appliance 400 can include a seal (not shown) between door 408 and cabinet 402 that assists with maintaining heat and cooking vapors within cooking chamber 404 when door 408 is closed as shown in FIGS. 6 and 7. Multiple parallel glass panes 422 provide for viewing the contents of cooking chamber 404 when door 408 is closed and assist with insulating cooking chamber 404. A baking rack 442 is positioned in cooking chamber 404 for the receipt of food items or utensils containing food items. Baking rack 442 is slidably received onto embossed ribs or sliding rails 444 such that rack 442 may be conveniently moved into and out of cooking chamber 404 when door 408 is open.

One or more heating elements may be included at the top, bottom, or both of cooking chamber 404 to provide heat to cooking chamber 404 for cooking. Such heating element(s) can be gas, electric, microwave, or a combination thereof. For example, in the embodiment shown in FIG. 7, oven appliance 400 includes a top heating element 424 which, in the illustrated example embodiment is an electric resistance heating element 424, and a bake heating element or bottom heating element 426, which, in the illustrated example embodiment is a gas burner 426, and bottom heating element 426 is positioned adjacent to and below bottom wall 414.

Also as may be seen in FIG. 7, the gas burner 426 is positioned within the cabinet 402 and outside of the chamber 404. In some embodiments, for example as illustrated in FIG. 7, the gas burner 426 may be a bake heating element or bottom heating element and may be positioned below the chamber 404 and separated from the chamber 404 by a partition, e.g., the bottom wall 414 of the chamber 404. The gas burner 426 may be in thermal communication and in fluid communication with the chamber by a flow path extending through one or more apertures or openings 450 in the bottom wall 414. In at least some embodiments, the flow path may extend from the gas burner 426, e.g., from ports thereof, through the opening(s) 450, and into the cooking chamber 404.

In the illustrated example embodiment, oven appliance 400 also has a convection heating element 436 and convection fan 438 positioned adjacent back wall 416 of cooking chamber 404. Convection fan 438 is powered by a convection fan motor 439. Further, convection fan 438 can be a variable speed fan—meaning the speed of fan 438 may be controlled or set anywhere between and including, e.g., zero and one hundred percent (0%-100%). In certain embodiments, oven appliance 400 may also include a bidirectional triode thyristor (not shown), i.e., a triode for alternating current (TRIAC), to regulate the operation of convection fan 438 such that the speed of fan 438 may be adjusted during operation of oven appliance 400. The speed of convection fan 438 can be determined by controller 440. In addition, a sensor 437 such as, e.g., a rotary encoder, a Hall effect sensor, or the like, may be included at the base of fan 438, for example, between fan 438 and motor 439 as shown in the exemplary embodiment of FIG. 7, to sense the speed of fan 438. The speed of fan 438 may be measured in, e.g., revolutions per minute (“RPM”). In some embodiments, the convection fan 438 may be configured to rotate in two directions, e.g., a first direction of rotation and a second direction of rotation opposing the first direction of rotation. For example, in some embodiments, reversing the direction of rotation, e.g., from the first direction to the second direction or vice versa, may still direct air from the back of the cavity. As another example, in some embodiments reversing the direction results in air being directed from the top and/or sides of the cavity rather than the back of the cavity. Additionally, the convection heating features are optional and are shown and described herein solely by way of example. In other embodiments the oven appliance 400 may include different convection heating features or may not include convection heating features at all.

In various embodiments, more than one convection heater, e.g., more than one convection heating elements 436 and/or convection fans 438, may be provided. In such embodiments, the number of convection fans and convection heaters may be the same or may differ, e.g., more than one convection heating element 436 may be associated with a single convection fan 438. Similarly, more than one top heating element 424 and/or more than one bottom heating element 426 may be provided in various combinations, e.g., one top heating element 424 with two or more bottom heating elements 426, two or more bottom heating elements 426 with no top heating element 424, etc.

Oven appliance 400 includes a user interface 428 having a display 430 positioned on an interface panel 432 and having a variety of controls 434. Interface 428 allows the user to select various options for the operation of oven 400 including, e.g., various cooking and cleaning cycles. Operation of oven appliance 400 can be regulated by a controller 440 that is operatively coupled to, i.e., in communication with, user interface 428, heating elements 424, 426, and other components of oven 400 as will be further described. In some embodiments, display 430 can also be used as an input device. For instance, in such embodiments, display 430 can be a touchscreen device. In some embodiments, display 430 is the only input device on interface panel 432, e.g., the controls 434 may be omitted and the input functionality may be provided by the touchscreen display 430.

For example, in response to user manipulation of the user interface 428, controller 440 can operate the heating element(s). Controller 440 can receive measurements from one or more temperature sensors (not shown) which are in or in thermal communication with the cooking chamber 404. Controller 440 may also provide information such as a status indicator, e.g., a temperature indication, to the user with display 430. Controller 440 can also be provided with other features as will be further described herein.

Controller 440 may include a memory and one or more processing devices such as microprocessors, CPUs, or the like, such as general or special purpose microprocessors operable to execute programming instructions or micro-control code associated with operation of oven appliance 400. The memory may represent random access memory such as DRAM or read only memory such as ROM or FLASH. In one embodiment, the processor executes programming instructions stored in memory. The memory may be a separate component from the processor or may be included onboard within the processor. The memory can store information accessible by the processor(s), including instructions that can be executed by processor(s). For example, the instructions can be software or any set of instructions that when executed by the processor(s), cause the processor(s) to perform operations. For the embodiment depicted, the instructions may include a software package configured to operate the system, e.g., to execute exemplary methods of operating the oven appliance 400. Controller 440 may also be or include the capabilities of either a proportional (P), proportional-integral (PI), or proportional-integral-derivative (PID) control for feedback-based control implemented with, e.g., temperature feedback from one or more sensors such as temperature sensors and/or probes, etc.

Controller 440 may be positioned in a variety of locations throughout oven appliance 400. In the illustrated embodiment, controller 440 is located next to user interface 428 within interface panel 432. In other embodiments, controller 440 may be located under or next to the user interface 428, otherwise within interface panel 432, or at any other appropriate location with respect to oven appliance 400. Generally, controller 440 will be positioned within the cabinet 402. In the embodiment illustrated in FIG. 6, input/output (“I/O”) signals are routed between controller 440 and various operational components of oven appliance 400 such as heating elements 424, 426, 436, convection fan 438, controls 434, display 430, alarms, and/or other components as may be provided. In one embodiment, user interface 428 may represent a general purpose I/O (“GPIO”) device or functional block.

Although shown with touch type controls 434, it should be understood that controls 434 and the configuration of oven appliance 400 shown in FIGS. 6 and 7 is provided by way of example only. More specifically, user interface 428 may include various input components, such as one or more of a variety of electrical, mechanical, or electro-mechanical input devices including rotary dials, push buttons, and touch pads. User interface 428 may include other display components, such as a digital or analog display device designed to provide operational feedback to a user. User interface 428 may be in communication with controller 440 via one or more signal lines or shared communication busses.

While oven 400 is shown as a wall oven, the present invention could also be used with other cooking appliances such as, e.g., a stand-alone oven, an oven with a stove-top, or other configurations of such ovens. Numerous variations in the oven configuration are possible within the scope of the present subject matter. For example, variations in the type and/or layout of the controls 434, as mentioned above, are possible. As another example, the oven appliance 400 may include multiple doors 408 instead of or in addition to the single door 408 illustrated. Such examples include a dual cavity oven, a French door oven, and others. As still another example, one or more of the illustrated heating elements may be substituted with microwave heating elements, or any other suitable heating elements. The examples described herein are provided by way of illustration only and without limitation.

In some embodiments, e.g., as illustrated FIG. 8, the present disclosure may include a plurality of cooking appliances 10 and a remote user interface device 1000. For example, embodiments of the present disclosure include methods of operating one or more cooking appliances 10 and guided cooking methods wherein some or all of the cooking steps are performed by or with one or more cooking appliances 10. In FIG. 8, the remote user interface device 1000 is a smart phone, which is just one example embodiment of a remote user interface device 1000, and additional possible example remote user interface devices 1000 will be described in more detail below. As illustrated in FIG. 8, each cooking appliance 10 of the plurality of cooking appliances 10 is communicatively coupled to or paired/matched with the remote user interface device 1000. For example, the plurality of cooking appliances 10 may communicate wirelessly with the remote user interface device 1000, e.g., the plurality of cooking appliances 10 may send and receive wireless signals to and from the remote user interface device 1000.

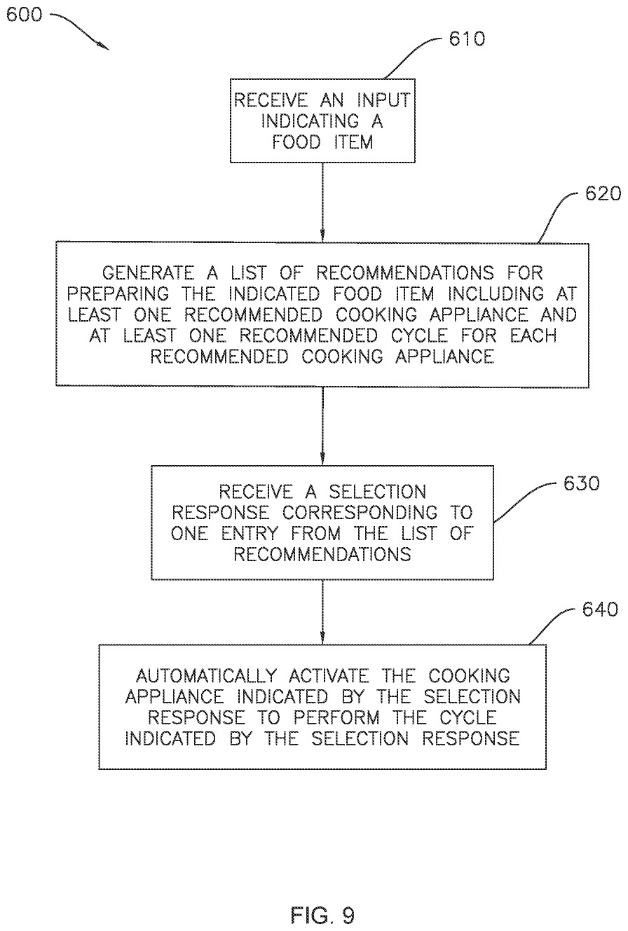

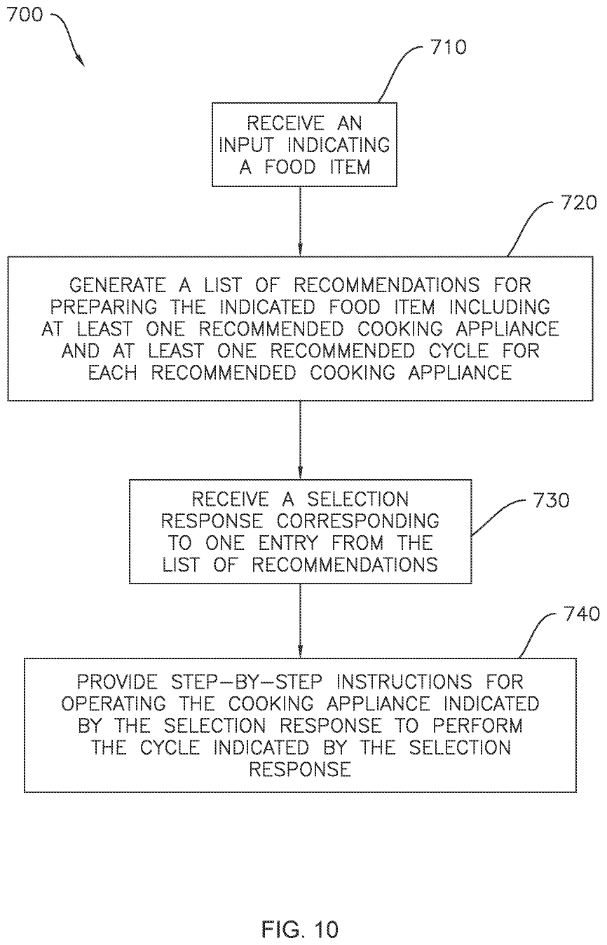

As illustrated in FIGS. 9 and 10, embodiments of the present disclosure also include methods for operating a cooking appliance, such as the exemplary guided cooking methods 600 and 700 illustrated in FIGS. 9 and 10. The cooking appliance which is operated in the exemplary methods 600 and 700 may be one of a plurality of cooking appliances, e.g., one of the plurality of cooking appliances 10 that communicates with a remote user interface device 1000, as illustrated in FIG. 8. As mentioned, the plurality of cooking appliances 10 may include any of the foregoing exemplary appliances described herein above, e.g., any two or more of a cooktop, a multi-function oven appliance, and/or a range appliance. Further, the plurality of appliances 10 may also include, e.g., a microwave oven. For example, the microwave oven appliance may include features generally similar to the microwave features described above in context of the cooking appliance 200 (multi-function oven appliance), with or without additional heating elements, such as a microwave only oven appliance, or a microwave oven appliance which also includes one or more additional heating modules, such as an induction heating module, a convection heating module, and/or one or more heat lamps, etc. Also by way of example, one or more of the cooking appliances 10 may include various combinations of heating modules and/or heating elements as in any of the foregoing examples, such as an oven appliance with only electric radiant heating (e.g., without convection), an oven appliance with gas bake heating element and convection heating, an oven appliance with ceramic heating modules and heat lamps, among numerous other possible combinations. As another example, the plurality of cooking appliances 10 may also include an air fryer, toaster oven, pressure cooker, slow cooker, or other similar cooking appliances which are recognized by those of ordinary skill in the art.

Further, methods according to the present disclosure use a remote user interface device 1000 (see, e.g., FIG. 8) which provides a single, streamlined interface across all of the cooking appliances 10 of the plurality of cooking appliances 10. Thus, the present disclosure provides an improved user interface as compared to, e.g., a separate user interface for each cooking appliance 10 of the plurality of cooking appliances 10. The remote user interface device 1000 is “remote” at least in that it is spaced apart from and not physically connected to at least one of the cooking appliances 10. For example, in some embodiments, the remote user interface device 1000 may be a separate, stand-alone device from the plurality of cooking appliances 10 which communicates with one or more cooking appliance of the plurality of cooking appliances 10 wirelessly, e.g., as illustrated in FIG. 8. In additional exemplary embodiments, the remote user interface device 1000 may be a display or interface of one of the cooking appliances 10, such as the display device 220 described above with reference to FIGS. 3-5, or the user interface 428 and/or display 430 described above with reference to FIG. 6, such that the remote user interface device 1000 is remote from every other cooking appliance 10 of the plurality of cooking appliance 10. In some embodiments, the remote user interface device 1000 may be an interactive assembly such as the exemplary interactive assembly 110 described above in context of FIGS. 1 and 2. In other embodiments, any suitable device separate from at least one of the cooking appliances that is configured to provide and/or receive communications, information, data, or commands from a user may serve as the remote user interface device 1000, such as a smartphone, smart watch, personal computer, smart home system, or other similar device. For example, the remote user interface device 1000 may be a smartphone operable to store and run applications, also known as “apps,” and some or all of the method steps disclosed herein may be performed by a smartphone app.

Turning now specifically to FIG. 9, an exemplary method 600 for guided cooking using a plurality of cooking appliances and a remote user interface device is illustrated. As shown in FIG. 9, the method 600 may include a step 610 of receiving an input indicating a food item. The receiving step 610 may be performed by the remote user interface device. Method 600 may further include a step 620 of generating a list of recommendations for preparing the indicated food item. The list of recommendations includes at least one recommended cooking appliance of the plurality of cooking appliances and at least one recommended cycle for each recommended cooking appliance. The generating step 620 may also be performed by the remote user interface device. The at least one recommended cycle may include a single temperature or other operation of the cooking appliance and a single corresponding time duration to provide the temperature or perform the operation. The at least one recommended cycle may also include a profile or sequence of operations, such as providing multiple temperatures or heating levels (e.g., operating a microwave module at 50% power followed by 100%) over a plurality of corresponding time periods, e.g., in a precision cooking cycle.

The list of recommendations may be presented as a single list at one time from which the user may pick a desired entry from the list, or each item in the list may be presented sequentially with a binary (YES/NO) prompt for each item, until an affirmative (YES) response is received for the selected entry in the list of recommendations. The list of recommendations may be provided by the remote user interface device in one or more various forms, e.g., as audio and/or visual output from the remote user interface device. For example, the list of recommendations may be displayed, e.g., provided as a visual output, on a display of the remote user interface device. As another example, the list of recommendations may also or instead be read aloud, e.g., produced as an audio output by the remote user interface device.

As illustrated in FIG. 9, the method 600 may further include a step 630 of receiving a selection response corresponding to one entry from the list of recommendations via the remote user interface device. For example, the selection response may be a YES response as described above, or may include picking the selected entry from the list of recommendations which is presented at once, also as described above.

In response to the selection response, the method 600 may then proceed to a step 640 of automatically activating the cooking appliance indicated by the selection response to perform the cycle indicated by the selection response. For example, the remote user interface device may be wirelessly connected to the selected cooking appliance and may thereby transmit a signal from the remote user interface device to the cooking appliance indicated by the selection response. The signal may cause the cooking appliance indicated by the selection response to activate and to perform the cycle indicated by the selection response, thus automatically activating the cooking appliance, i.e., without direct interaction with the cooking appliance by the user.

For example, the cooking appliance may be operable to perform a precision cooking cycle, e.g., which includes multiple stages and various parameters. In such embodiments, the remote user interface device may, in response to a selection input that indicates the precision cooking cycle, wirelessly communicate the precision cooking cycle to the selected cooking appliance. For example, the remote user interface device may be operable to, and/or the method 600 may include, starting the cooking appliance with a single input, e.g., one click or one touch. Thus, the user interface and related methods of the present disclosure may thereby advantageously avoid deep menus and multiple clicks or touches in order to activate the precision cooking cycle.

Turning now to FIG. 10, another exemplary guided cooking method 700 is illustrated. Similar to method 600 described above, the method 700 may include a step 710 of receiving, by the remote user interface device, an input indicating a food item (similar to step 610 described above). Method 700 may also include a step 720 of generating, by the remote user interface device, a list of recommendations for preparing the indicated food item. Similar to step 620 described above, the list of recommendations includes at least one recommended cooking appliance of the plurality of cooking appliances and at least one recommended cycle for each recommended cooking appliance. Method 700 may further include a step 730 of receiving a selection response corresponding to one entry from the list of recommendations via the remote user interface device (similar to step 630 described above).

The method 700 may be used with one or more cooking appliances of the plurality of cooking appliances that are not in wireless communication with the remote user interface device. Thus, the method 700 may include guiding the user for manual activation of the selected cooking appliance. For instance, the method 700 may include a step 740 of providing step-by-step instructions, from the remote user interface device, for operating the cooking appliance indicated by the selection response to perform the cycle indicated by the selection response. For example, the method may include walking the user through manually configuring a multi-parameter cooking cycle, such as entering multiple successive inputs via the control panel of the cooking appliance, where the remote user interface identifies each input to select in the order in which the inputs are to be selected whereby the cooking appliance will then perform the selected cycle in response to the inputs.

In some embodiments of method 600 or of method 700, the input may also indicate a desired serving time for the food item. In such embodiments, the list of recommendations may also be based on the desired serving time in addition to the food type. For example, when the desired serving time is as soon as possible (ASAP) the list of recommendations may only include cooking appliances with the shortest cycles available and/or only the shortest cycles for a given appliance. As another example, when the desired serving time is a number of minutes and/or hours, the list of recommendations may only include cooking appliances and/or cycles which are capable of cooking the indicated food item in the specified time (number of minutes and/or hours) or less. Moreover, in some embodiments, the list of recommendations may also include an estimated completion time for each entry in the list of recommendations.

As mentioned, the user interface of the present disclosure is advantageously simplified. For example, the user interface and/or method may only require the food item identification in order to generate the list of recommendations. In some embodiments, the user interface and/or method may only require the food item identification and desired serving time in order to generate the list of recommendations. Thus, in some exemplary embodiments, the list of recommendations may be generated by the remote user interface device without any user input other than the food item and serving time.

In one example, the food item may be rice. For example, the input may include an initial indication of a general food type, such as rice, via, e.g., voice recognition, image recognition (such as scanning a bar code or QR code on a food package, or text or a logo, etc., on a food package to identify the food item), a selection from a menu tree, a one-layer deep alphabetical index, etc. Following the initial input, e.g., of the general food type, at least some food types may result in additional prompts, such as when the general food type is rice, options to select white, brown, or wild rice, and/or short grain, long grain, or basmati rice to further specify the food item to be cooked. In response to such input, the remote user interface device may then generate a list of recommendations. Continuing the rice example, the list of recommendations may include at least one cooking appliance, such as a pressure cooker and an oven appliance, when such appliances are included in the plurality of cooking appliances. The list of recommendations may further include at least one recommended cycle for each recommended cooking appliance, such as a cycle of a certain time length, e.g., about twelve minutes, for the pressure cooker and, e.g., about eighteen minutes for the oven appliance.

In another example, the food item may be sweet potatoes. For example, in response to an initial input of sweet potatoes, the method, e.g., method 600 and/or method 700, may also include providing additional prompts, such as type, e.g., whole or cubed, and quantity of sweet potatoes in order to further specify the food item to be cooked. Continuing the sweet potatoes example, the list of recommendations may include a microwave oven appliance with a five minute cycle, a range appliance with a one hour cycle, and a pressure cooker with a fifteen minute cycle. When the selection response indicates a cooking appliance with wireless capability, e.g., the range appliance, the method may then include confirming the selected cycle and activating the selected appliance, e.g., the range appliance, by the remote user interface device. When the selection response indicates a cooking appliance that is not wirelessly connected to the remote user interface device, e.g., the pressure cooker appliance, the method may then include providing step-by-step instructions, from the remote user interface device, for operating the cooking appliance indicated by the selection response to perform the cycle indicated by the selection response, such as a series of steps to activate the pressure cooker in the selected mode, with the selected options, if any, and the selected time duration.

In order to generate the list of recommendations, the user interface and/or method may draw on an inventory of cooking appliances which contains information about each cooking appliance of the plurality of cooking appliances, e.g., identifying information and usage information such as configuration/capacity information for each cooking appliance. For example, the method may include searching the inventory to select cooking appliances from the plurality of cooking appliances to recommend. Thus, the method 600 or 700 may also include a step or steps for creating the inventory prior to the further steps of the method described above, such as preparing an inventory of the plurality of cooking appliances prior to receiving the input indicating the food item at step 610 or 710. For example, creating the inventory may be performed as an initial, one-time, setup step. In some embodiments, the inventory may be updated at various points in time, such as between iterations of the method, e.g., when the user acquires a new cooking appliance, that new appliance may be added to the appliance inventory and thereby be one of the plurality of cooking appliances in future iterations of the method steps described above after the new appliance is added to the inventory.

Cooking appliances may be added to the inventory in various ways. For example, connected appliances which communicate wirelessly with the remote user interface device may be added to the inventory using a one-click discovery process, where the identifying information and usage information are wirelessly transmitted to the remote user interface device from the cooking appliance in response to a single user input, e.g., on the remote user interface device or via a control panel on the cooking appliance. As another example, non-wireless appliances could be added by selecting from a list of known options, downloading specifications from the internet, or manually entering specifications. Additional configuration settings may be included when preparing the inventory, such as displaying wattage and other usage information or capacity for each cooking appliance. Thus, in some embodiments, the method may include preparing the inventory by wirelessly receiving a signal from one cooking appliance of the plurality of cooking appliances, where the signal contains usage information for the one cooking appliance, and populating the inventory with the usage information for the one cooking appliance. In additional exemplary embodiments, the method may include preparing the inventory by receiving an input comprising identifying information for one cooking appliance of the plurality of cooking appliances, e.g., brand name and/or model name of the one cooking appliance, then retrieving usage information for the one cooking appliance from a database based on the identifying information, e.g., looking up the brand and/or model online in order to download the specifications for the one cooking appliance, and populating the inventory with the usage information for the one cooking appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A guided cooking method using a plurality of cooking appliances and a remote user interface device, the method comprising:
receiving, by the remote user interface device, an input indicating a food item;
generating, by the remote user interface device, a list of recommendations for preparing the indicated food item, the list of recommendations comprising at least one recommended cooking appliance of the plurality of cooking appliances and at least one recommended cycle for each recommended cooking appliance;
receiving a selection response corresponding to one entry from the list of recommendations via the remote user interface device; and
transmitting a signal from the remote user interface device to the cooking appliance indicated by the selection response activating the cooking appliance indicated by the selection response to perform the cycle indicated by the selection response.

2. The method of claim 1, wherein the input also indicates a serving time for the food item.

3. The method of claim 2, wherein the list of recommendations also comprises an estimated completion time for each entry in the list of recommendations.

4. The method of claim 2, wherein the list of recommendations is generated by the remote user interface device without any user input other than the food item and serving time.

5. The method of claim 1, further comprising preparing an inventory of the plurality of cooking appliances prior to receiving, by the remote user interface device, the input indicating the food item.

6. The method of claim 5, wherein preparing the inventory comprises wirelessly receiving, by the remote user interface device, a signal from one cooking appliance of the plurality of cooking appliances, the signal containing usage information for the one cooking appliance, and populating the inventory with the usage information for the one cooking appliance.

7. The method of claim 5, wherein preparing the inventory comprises receiving, by the remote user interface device, an input comprising identifying information for one cooking appliance of the plurality of cooking appliances; retrieving, by the remote user interface device, usage information for the one cooking appliance from a database based on the identifying information; and populating the inventory with the usage information for the one cooking appliance.

8. The method of claim 1, further comprising displaying the list of recommendations on a display of the remote user interface device.

9. The method of claim 1, further comprising producing an audio output of the list of recommendation by the remote user interface device.

10. A guided cooking method using a plurality of cooking appliances and a remote user interface device, the method comprising:
receiving, by the remote user interface device, an input indicating a food item;
generating, by the remote user interface device, a list of recommendations for preparing the indicated food item, the list of recommendations comprising at least one recommended cooking appliance of the plurality of cooking appliances and at least one recommended cycle for each recommended cooking appliance;
receiving a selection response corresponding to one entry from the list of recommendations via the remote user interface device; and
providing step-by-step instructions, from the remote user interface device, for operating the cooking appliance indicated by the selection response to perform the cycle indicated by the selection response.

11. The method of claim 10, wherein the input also indicates a serving time for the food item.

12. The method of claim 11, wherein the list of recommendations also comprises an estimated completion time for each entry in the list of recommendations.

13. The method of claim 11, wherein the list of recommendations is generated by the remote user interface device without any user input other than the food item and serving time.

14. The method of claim 10, further comprising preparing an inventory of the plurality of cooking appliances prior to receiving, by the remote user interface device, the input indicating the food item.

15. The method of claim 14, wherein preparing the inventory comprises wirelessly receiving, by the remote user interface device, a signal from one cooking appliance of the plurality of cooking appliances, the signal containing usage information for the one cooking appliance, and populating the inventory with the usage information for the one cooking appliance.

16. The method of claim 14, wherein preparing the inventory comprises receiving, by the remote user interface device, an input comprising identifying information for one cooking appliance of the plurality of cooking appliances; retrieving, by the remote user interface device, usage information for the one cooking appliance from a database based on the identifying information; and populating the inventory with the usage information for the one cooking appliance.

17. The method of claim 10, further comprising displaying the list of recommendations on a display of the remote user interface device.

18. The method of claim 10, further comprising producing an audio output of the list of recommendation by the remote user interface device.
